(19) United States
(12) Patent Application Publication
(10) Pub. No.: US 2006/0087560 A1
(43) Pub. Date: Apr. 27, 2006

(54) Surveillance camera

(75) Inventors: Dov Moran, Kfar Saba (IL); Eyal Bychkov, Hod Hasharon (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS LTD.

(21) Appl. No.: 11/006,696

(22) Filed: Dec. 8, 2004

Related U.S. Application Data
(60) Provisional application No. 60/621,013, filed on Oct. 22, 2004.

(51) Int. Cl. H04N 5/225; H04N 7/18; H04N 9/47

(52) U.S. Cl. 348/207.1; 348/143

(57) ABSTRACT

A method for operating a camera includes connecting the camera to a computer; the camera is programmed by storing operative steps in memory within the camera. The programming is performed using an application running on the computer. On completing the programming, the camera is disconnected from the computer and further programming is disabled and the program is executed. Preferably, the program includes correlating a photographic image with a previously stored photographic image and overwriting in memory a photographic image substantially identical to the previously stored photographic image. Preferably, the camera further includes manual controls functional solely during manual photography and disabled during surveillance photography.

### CROSS REFERENCE TO RELATED APPLICATIONS

This application claims the benefit from U.S. provisional application 60/621,013 filed Oct. 22, 2004 by the present inventors.

### FIELD AND BACKGROUND OF THE INVENTION

The present invention relates to surveillance photography and, more particularly, to a surveillance camera that photographs according to a program previously stored in the camera.

In many cases a homeowner wants to know what is happening in his home during his absence, without anyone else knowing the homeowner is watching. For example, the homeowner may wish to know if his maid is stealing money when she is alone cleaning his home. The homeowner can buy a miniature video or still camera, and hide the camera in a secret place in his home so that the camera is not noticeable by an unsuspecting person. For a surveillance camera that needs to be hidden, additional cost arises from manufacturing a miniature camera, and from camouflaging the camera and any connections to the camera. Therefore most people will not use such a camera and they will continue to suspect the maid without having an alternative to know for sure.

Video cameras are widely used for surveillance purposes in stores, banks, parking lots, buildings, train stations, street intersections, highways and other areas. Typically, surveillance cameras are mounted on a pan/tilt head designed to rotate about a vertical axis for panning as well as about a horizontal axis for tilting. Typically, a pan/tilt head is normally mounted e.g. to a wall and is motorized with a separate motor for each of the motions. The motors are typically hard wired to a control at a fixed location and can be operated continuously, intermittently or for set time periods to provide routine scanning or can be operated by an attendant. Normally, when operated by an attendant, the camera control is at a remote location and the attendant manually orients the video camera by means of a hard wired control while observing a monitor. Alternatively, surveillance cameras use a wireless interface and control is computerized, e.g. using the Internet. Consequently, conventional surveillance cameras require a considerable investment in equipment and infrastructure. Still pictures photography is not typically used for surveillance because it is not practical to have a still pictures camera continuously take pictures, and there are no prior art flexible methods for programming such camera for selectively taking pictures.

There is thus a need for, and it would be highly advantageous to have a surveillance camera that photographs solely according to a program previously stored in the camera and does not require expensive infrastructure to control the camera.

### SUMMARY OF THE INVENTION

According to the present invention there is provided a method for operating a camera. The method includes (a) connecting the camera to a computer; (b) upon connecting to the computer, the camera is programmed by storing operative steps in memory within the camera. The programming is performed using an application running on the computer. On completing the programming, the camera is (c) disconnected from the computer (d) The operative steps of the program are executed by photographing according to the stored program. Preferably, disconnecting disables further programming and the programming is performed solely while the camera is operatively connected to the computer. Preferably, the method, further includes, prior to the photographing (e) authenticating a user of the application and upon authenticating, programming an additional operative step or otherwise modifying the program. Preferably, the method further includes authenticating a user of the application and then retrieving images from the camera. Preferably, the method includes sensing, wherein an operative step is based on the sensing. The sensing options include motion sensing, thermal sensing, pressure sensing, sound sensing and light sensing. Preferably, the program includes providing a time value for an operative step. Preferably the program includes instructions for overwriting at least one previously stored photographic image. Preferably, the program includes instructions for correlating a photographic image with a previously stored photographic image and when the images are substantially identical, overwriting in memory one of the photographic images.

According to the present invention there is provided a camera including: (a) an interface which operatively connects the camera to a computer; (b) a memory which stores a program while uploading the program solely through the interface; and (c) a processor operatively connected to the memory. The processor reads the program and photographs according to the program. Preferably, the interface is wireless. Preferably, the interface is operatively disconnected from the computer during photographing according to the program. Preferably, the camera further includes manual controls functional during manual photography, whereby the manual controls are disabled during surveillance photography. Preferably, the interface provides the sole control for the camera. Preferably, the camera, further includes a dummy control rendering the camera to appear like a conventional camera. Preferably, the camera further includes a clock for providing a time value to a photographic image produced during the photography. Preferably, the camera further includes a sensor interface, wherein an operative step is based on a sensing input at the sensor interface. Preferably, the camera photograph solely according to the program.

According to the present invention there is provided a photographic system including: (a) a computer including an interface; and (b) a camera including a processor and a memory that stores a program. The program is uploaded solely through the interface, and the processor operatively connected to the memory photographs according to the stored program. Preferably, the interface is operatively disconnected from the computer during the photography according to the program. Preferably, the computer further includes an authentication mechanism that authenticates an authorized user for operating the camera. Preferably, the photographic system further includes a sensor operatively connected to the camera and an operative step is based on an input from the sensor. Preferably, the camera further includes manual controls functional solely during manual photography; the manual controls are disabled during photography according to the program. Preferably, the processor photographs solely according to the program.

According to the present invention there is provided a method for operating a camera, the method comprising the steps of: (a) operatively connecting the camera to a computer; (b) upon the connecting, programming an operative step of the camera, the programming is performed using an application running on the computer; (c) on completing the programming, authenticating an authorized user thereby enabling photographing according to the program wherein the enabling of photography operatively disconnects the camera from the computer for further programming. Preferably, on completing the photographing, the method includes (d) further authenticating an authorized user; and (e) performing an action including modifying the program; and/or retrieving an image from the camera. Preferably, the method, further includes sensing, wherein an operative step is based on the sensing. The sensing options include motion sensing, thermal sensing, pressure sensing, sound sensing and/or light sensing. Preferably, the program includes providing a time value for an operative step. Preferably, the program includes instructions for correlating a photographic image with a previously stored photographic image and when a photographic image is substantially identical to one of the the previously stored photographic images overwriting one of the images in memory.

### BRIEF DESCRIPTION OF THE DRAWINGS

The invention is herein described, by way of example only, with reference to the accompanying drawings, wherein:

FIG. 1 is a block diagram of a surveillance camera according to an embodiment of the present invention;

FIG. 2 is a flow diagram of a method of surveillance photography, according to an embodiment of the present invention;

FIG. 3 is a flow diagram of a method of surveillance photography, according to a a second embodiment of the present invention; and

FIG. 4 is a flow diagram of photographic image management in a surveillance camera, according to an embodiment of the present invention.

### DESCRIPTION OF THE PREFERRED EMBODIMENTS

The present invention is of a surveillance camera and a method of surveillance photography. Specifically, the surveillance camera is programmed exclusively by a secure application running on a personal computer. The surveillance camera is then placed in a position for surveillance and photographs according to the stored program. After surveillance photography, the camera is retrieved and the photographs are viewed or otherwise retrieved from the camera solely by an authorized user.

The principles and operation of a system and method of surveillance photography, according to the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, principal intentions of the present invention are to provide a versatile method for surveillance photography that doesn't require expensive equipment or infrastructure, and provide a mechanism to authenticate a user authorized to use the surveillance camera insuring that no tampering of photographic images can occur.

Surveillance is performed by low-cost digital camera that connects to a computer for receiving photographic exposure instructions. The camera is then disconnected from the computer and placed by the user, e.g. at home, covering the scene to be tracked. During surveillance time, the camera does not indicate activity, e.g. making clicking sounds. Moreover, during surveillance the camera is not connected to the computer or to any other device. Therefore, even though the camera is visible, the tracked person has no reason to suspect he/she is being watched. Because there is no need to hide the camera, the camera does not need to be small, since there are no size constraints and controls are not required in the camera, the camera can be cheaply built.

Subsequent to surveillance photography, it is not desirable for the user to be required to sort through a large number, e.g. hundreds of stored images. Therefore, according to an embodiment of the present invention, a photographic image management feature is desired during surveillance photography, which chooses and protects important or relevant images and allows only irrelevant images to be overwritten. This feature frees memory during photography and reduces the memory required in the surveillance camera.

It should be noted that while the discussion herein is directed to a still camera the principles of the present invention may be adapted for use in, and provide benefit for a video camera as well as other mechanisms for recording information, e.g. sound recording. Furthermore the storage mechanism may be of any such mechanisms known in the art including analog media, and digital storage media including random access memory, flash memory, and EEPROM. The terms “memory”, and “storage” are used herein interchangeably. The term “camera” refers to both a camera for photographing “still” pictures as well as a camera for “moving” pictures, e.g video. The term “manual photography” refers to conventional photography as opposed to surveillance photography of the present invention. A “dummy” control is defined herein to be a control without a function other than appearing like a functional control.

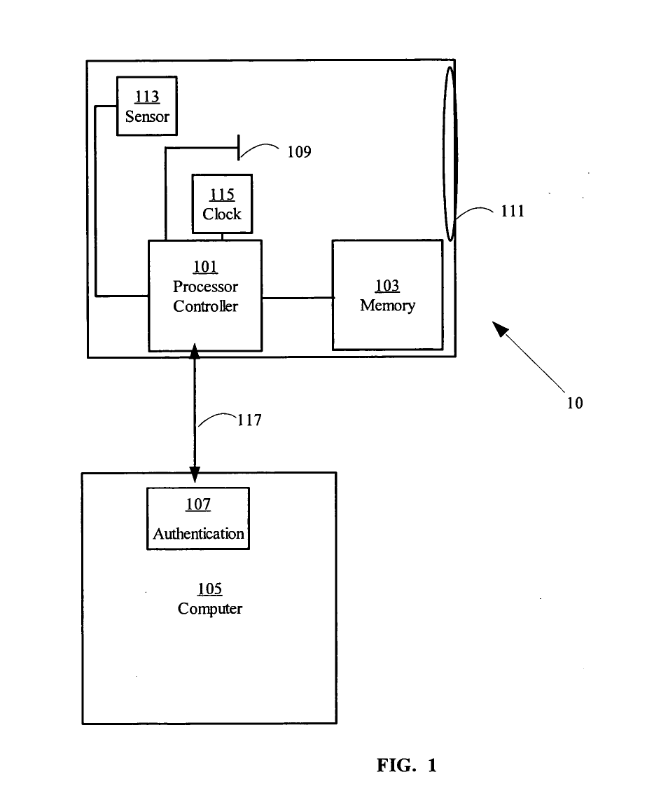

Referring now to the drawings, FIG. 1 is a block diagram of a surveillance camera 10, according to an embodiment of the present invention. Surveillance camera 10 includes an optical system including a lens 111 for focusing images onto an imaging sensor 109, e.g. a charge coupled device. Imaging sensor 109 is operatively connected to a processor or controller 101 which stores the images in memory 103. Surveillance camera 10 optionally includes one or more additional sensors 113, operatively connected to processor 101, for detecting external stimuli including motion, heat, changes in pressure, sound or light. Alternatively, surveillance camera 10 includes an interface including a connector to one or more external sensors. Surveillance camera optionally includes a real time clock or timer 115 operatively connected to processor 101.

Surveillance camera 10 is programmed through an interface 117, e.g. a universal serial bus (USB) interface, by a computer 105. Alternatively, interface 117 is a wireless interface, based on a public mobile telephone network (e.g. GSM). a private mobile telephone network (e.g. iDEN), a wireless data network (e.g. Wifi IEEE 802.11) or Bluetooth. Computer 105 further includes an authentication mechanism 107. Authentication mechanism 107 may be of any type known in the art, including a password, RFID token, biometric signature etc.

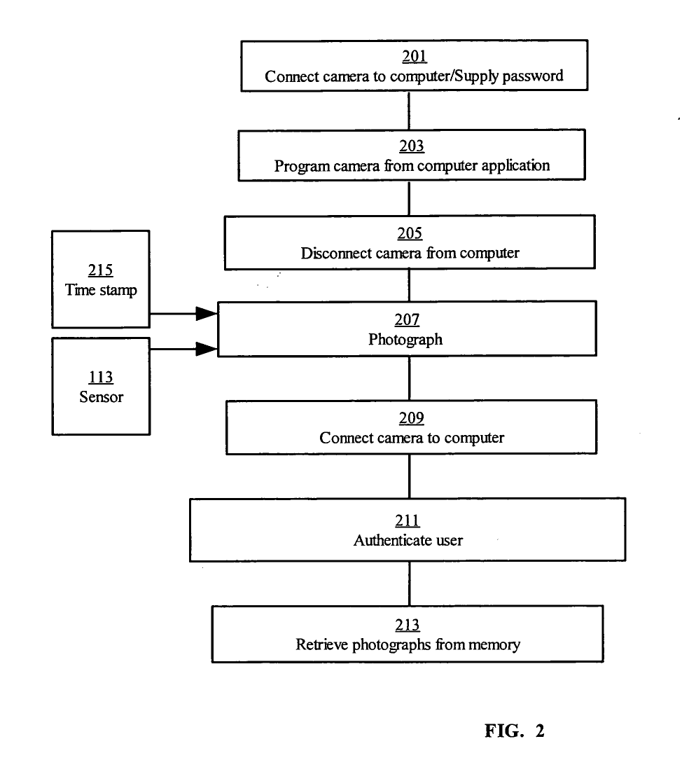

The operation of surveillance camera 10 is shown in the flow diagram of FIG. 2. Surveillance camera 10 is connected (step 201) to computer 105 using interface 117, e.g. USB. Surveillance camera 10 preferably includes a rechargeable battery that is charged upon connecting (step 201) to computer 105. An application is run on computer 105 to access processor 101 and memory 103. A first time user of surveillance camera 10 is typically required to supply a new password or other signature, e.g. biometric signature. Once a password is supplied, the user programs (step 203) surveillance camera 10 using the computer application running on computer 105. The application typically prompts the user regarding the times and/or frequency of photographing, for instance to photograph every five minutes starting from time 18:00. Another program may include photographing daily between 22:00 and 24:00. The program may include operative steps based on, e.g. triggered by, sensor 113. The program is stored in memory 103. After programming (step 203), surveillance camera 10 is disconnected (step 205) from computer 105. Disconnecting (step 205) secures camera 10 from any further programming. Surveillance camera 10 is placed in position and oriented in the direction of interest. Lens 111 is focused manually or automatically. Surveillance camera 10 proceeds to photograph (step 207) according to the program previously stored in memory 103. Furthermore, each photograph is typically time stamped or a time value is given (step 215) with a real time of the photograph. Preferably, photography (step 207) is soundless with no indication that photography (step 207) is taking place. After the surveillance photography, surveillance camera 10 is retrieved and reattached (step 209) to computer 105. The computer application authenticates the user, (step 211) e.g. by supplying the password, or otherwise using authentication mechanism 107. On authentication (step 211), the photographic images are retrieved (step 213). Preferably, the application provides a mechanism to digitally sign or encrypt the images or to provide a secondary password to prevent subsequent tampering of the images after the photographs are retrieved (step 213).

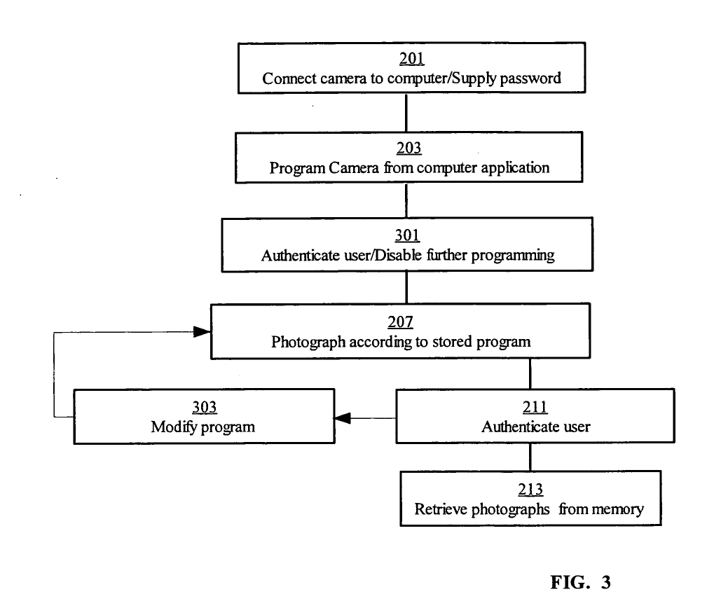

Another configuration of the present invention is shown in the flow diagram of FIG. 3. Referring to FIG. 3, surveillance camera 10 is connected (step 201) to computer 105 using for instance a wireless interface 115. Surveillance camera is programmed (step 203), the program stored in memory 103. A first time user supplies a password or otherwise a signature. After programming (step 203) the user is authenticated (step 301). Authentication of the user (step 301) disables any further programming and enables photography (step 207), according to the stored program. On completion of the photography (step 207), the user is authenticated again (step 211) allowing the user to retrieve (step 213) photographs from memory 103. Authentication (step 211) further enables the user to modify (step 303) the stored program.

In an embodiment of the present invention, camera 10 has no manual controls, e.g. keys, not even an on/off button. In another embodiment of the present invention, surveillance camera 10 includes manual controls for conventional photography, however the manual controls are disabled and not functional when surveillance camera 10 is operated according to the present invention. In still another embodiment of the present invention, camera 10 includes dummy controls that look like regular functional controls but are not functional. This is useful for making camera 10 appear to be a regular camera, so a suspect does not realize he is being watched.

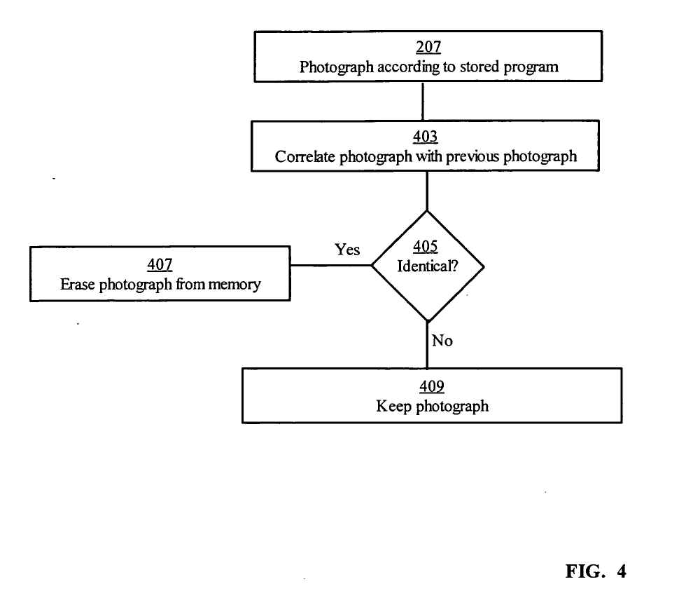

Reference is now made to FIG. 4, showing a method for managing photographic images in surveillance camera 10. During photography (step 207) photographic images are stored in memory 103. If memory 103 is completely used, i.e. written with photographic images, new photographic images preferably overwrite older photographic images in memory 103. Preferably, a mechanism is used to choose which previously stored photographic images are overwritten. In one such mechanism, each new photographic image is correlated (step 403) with for instance the previous photographic image. Correlation (step 403) is preferably performed by processor 101 using any correlation method known in the art. If the correlation is very high, then the images are substantially identical (decision block 405) and one of the images is erased (step 407) from memory 103, otherwise the image is kept (step 409).

The following example illustrates an embodiment of the present invention. Law enforcement officer, Joe Friday received a complaint of nightly pilfering of money from a coffee vending machine in the downtown mall. Joe recalls that he received surveillance camera 10 for testing. Joe connects (step 201) camera 10 to a USB port of his office computer (block 105). Joe then loads the software application for operating camera 10, and enters his NYPD identification number as a password. Joe programs camera 10 to trigger on motion detected by motion sensor 113 integrated inside surveillance camera 10 and to photograph continuously every twenty seconds after the trigger but only after midnight when the mall is expected to be empty of customers. Joe furthermore turns on a feature to overwrite highly correlated, i.e. substantially identical photographic images to free memory 103 during surveillance photography. Joe leaves the camera plugged in to charge the internal rechargeable battery. On his way home, Joe stops in the downtown mall, places surveillance camera 10 in a store window adjacent to the vending machine and orients the camera to photograph the vending machine according to the program stored in memory 103. Joe proceeded homeward. The next morning, Joe stopped again at the mall and picked up surveillance camera 10 and examined the coffee vending machine and saw no signs of pilfering. Nevertheless, when Joe arrived in the station, he plugged surveillance camera back into the USB port of his computer (block 105), ran the computer application, supplied his ID number as a password (authentication step 211) and viewed (step 213) the photographic images on his computer screen. In a few minutes, six consecutive stored images showed a perpetrator carrying a key to the vending machine. Joe was happy he didn't need to search through hundreds of nearly identical images due to the photographic image management feature. Joe printed the relevant photographs and submitted the photographs for criminal identification. Joe further secured the camera with a secondary password to further prevent tampering of stored images, placed the camera in an evidence bag and sealed the bag.

Therefore, the foregoing is considered as illustrative only of the principles of the invention. Further, since numerous modifications and changes will readily occur to those skilled in the art, it is not desired to limit the invention to the exact design and operation shown and described, and accordingly, all suitable modifications and equivalents may be resorted to, falling within the scope of the invention.

As such, those skilled in the art will appreciate that the conception, upon which this disclosure is based, may readily be utilized as a basis for the designing of other methods and systems for carrying out the several purposes of the present invention. It is important, therefore, that the claims be regarded as including such equivalent constructions insofar as they do not depart from the spirit and scope of the present invention.

While the invention has been described with respect to a limited number of embodiments, it will be appreciated that many variations, modifications and other applications of the invention may be made.

What is claimed is:

1. A method for operating a camera, the method comprising the steps of:
(a) operatively connecting the camera to a computer;
(b) upon said connecting, programming the camera thereby storing in a memory within the camera at least one operative step, wherein said programming is performed using an application running on said computer;
(c) on completing said programming, disconnecting the camera from the computer; and
(d) executing said at least one operative step, thereby photographing according to said programming.

2. The method, according to claim 1, wherein said disconnecting disables further programming.

3. The method, according to claim 1, wherein said programming is performed solely while the camera is operatively connected to said computer.

4. The method, according to claim 1, further comprising the step of, prior to said photographing:
(e) authenticating a user of said application.

5. The method, according to claim 4, wherein upon said authenticating
(f) performing at least one action selected from the group consisting of:
(i) programming an additional operative step; and
(ii) modifying said programming.

6. The method, according to claim 1, further comprising the steps of:
(e) authenticating a user of said application.
(f) retrieving at least one photographic image from the camera, said at least one photographic image input to the camera during said photographing.

7. The method, according to claim 1, further comprising the step of:
(e) at least one sensing, wherein said at least one operative step is based on said at least one sensing.

8. The method, according to claim 7, wherein said at least one sensing is selected from the group consisting of motion sensing, thermal sensing, pressure sensing, sound sensing and light sensing.

9. The method, according to claim 1, wherein said programming includes providing a time value for said at least one operative step.

10. The method, according to claim 1, wherein said programming includes instructions for overwriting at least one previously stored photographic image.

11. The method, according to claim 1, wherein said programming includes instructions for correlating at least one photographic image with at least one previously stored photographic image, wherein said at least one photographic image and said at least one previously stored photographic image are input to the camera during said photographing.

12. The method, according to claim 11, wherein said at least one photographic image is substantially identical to said at least one previously stored photographic image, further comprising the step of:
(e) overwriting in memory at least one image selected from the group of said at least one photographic image and said at least one previously stored photographic image.

13. A camera comprising:
(a) an interface which operatively connects the camera to a computer;
(b) a memory which stores a program wherein said program is loaded solely through said interface; and
(c) a processor operatively connected to said memory wherein said processor reads said program for photographing according to said program.

14. The camera, according to claim 13, wherein said interface is wireless.

15. The camera, according to claim 13, wherein said interface is operatively disconnected from said computer during said photographing according to said program.

16. The camera, according to claim 13, further comprising:
(d) at least one manual control functional during manual photography, wherein said at least one manual control is disabled during said photographing according to said program.

17. The camera, according to claim 13, wherein said interface provides the sole control for the camera.

18. The camera, according to claim 13, further comprising:
(d) at least one dummy control, whereby said at least one dummy control renders the camera to appear like a conventional camera.

19. The camera, according to claim 13, the camera further comprising
(d) a clock for providing a time value to at least one photographic image produced during said photography.

20. The camera, according to claim 13, wherein said program includes at least one operative step, the camera further comprising:
(d) a sensor interface, wherein said at least one operative step is based on a sensing input at said sensor interface.

21. The camera, according to claim 13, wherein said photographing is solely according to said program.

22. A photographic system comprising:
(a) a computer including an interface; and
(b) a camera including a processor and a memory which stores a program, said program being loaded into said memory solely through said interface, said processor operatively connected to said memory, said processor photographing according to said program.

23. The photographic system, according to claim 22, wherein said interface is operatively disconnected from said computer during said photographing according to said program.

24. The photographic system, according to claim 22, wherein said computer further includes an authentication mechanism which authenticates at least one authorized user for operating said camera.

25. The photographic system, according to claim 22, further comprising:
(c) a sensor operatively connected to said camera wherein an operative step of said program is based on an input from said sensor.

26. The photographic system, according to claim 22, wherein said camera further includes at least one manual control functional during manual photography, wherein said at least one manual control is disabled during said photographing according to said program.

27. The photographic system, according to claim 22, wherein said camera is controlled solely through said interface.

28. The photographic system, according to claim 22, wherein said camera further includes at least one dummy control, whereby said at least one dummy control renders said camera to appear like a conventional camera.

29. The photographic system, according to claim 22,
wherein said processor photographs solely according to said program.

30. A method for operating a camera, the method comprising the steps of:
(a) operatively connecting the camera to a computer;
(b) upon said connecting, programming at least one operative step of the camera, said programming being performed using an application running on said computer; and
(c) on completing said programming, authenticating at least one authorized user thereby enabling photographing according to said programming,
wherein said enabling operatively disconnects said camera from said computer for further programming.

31. The method, according to claim 30, wherein on completing said photographing, further comprising the steps of:
(d) further authenticating said at least one authorized user; and
(e) performing at least one action selected from the group of actions consisting of:
(i) modifying said programming; and
(ii) retrieving at least one image from the camera.

32. The method, according to claim 30, further comprising the step of:
(d) at least one sensing, wherein said at least one operative step is based on said at least one sensing.

33. The method, according to claim 32, wherein said at least one sensing is selected from the group consisting of motion sensing, thermal sensing, pressure sensing, sound sensing and light sensing.

34. The method, according to claim 30, wherein said programming includes providing a time value for said at least one operative step.

35. The method, according to claim 30, wherein said programming includes instructions for correlating at least one photographic image with at least one previously stored photographic image, wherein said at least one photographic image and said at least one previously stored photographic image are input to the camera during said photographing.

36. The method, according to claim 35, wherein said at least one photographic image is substantially identical to said at least one previously stored photographic image, further comprising the step of:
(d) overwriting in memory at least one image selected from the group of said at least one photographic image and said at least one previously stored photographic image.
